(19) United States
(12) Patent Application Publication
(10) Pub. No.: US 2025/0217865 A1
(43) Pub. Date: Jul. 3, 2025

(54) SYSTEM AND INFORMATION PROCESSING DEVICE

(71) Applicant: TOYOTA JIDOSHA KABUSHIKI KAISHA, Toyota-shi (JP)

(72) Inventors: Hideyuki TAKAKI, Okazaki-shi (JP); Yusuke TSUMITA, Kashiwa-shi (JP); Satoshi KAJIYAMA, Osaka (JP); Yasuhiro KOBATAKE, Nagoya-shi (JP); Takafumi YAMADAIRA, Nagoya-shi (JP); Kumiko HAYASHI, Nagoya-shi (JP); Tomoya KAJIKAWA, Nagoya-shi (JP)

(73) Assignee: TOYOTA JIDOSHA KABUSHIKI KAISHA, Toyota-shi (JP)

(21) Appl. No.: 18/897,318

(22) Filed: Sep. 26, 2024

(30) Foreign Application Priority Data
Dec. 27, 2023 (JP) 2023-221569

(51) Int. Cl. G06Q 30/0601

(52) U.S. Cl. CPC G06Q 30/0631; G06Q 30/0633

(57) ABSTRACT

The system includes an information processing device that provides a website that presents information on a vehicle waiting for delivery, which is purchased by a user, and a related product of the vehicle, and a terminal device, wherein the information processing device transmits product information indicating the related product to the terminal device, and the terminal device displays the product information and transmits order information indicating an order of the related product by the user to the information processing device.

### CROSS-REFERENCE TO RELATED APPLICATION

This application claims priority to Japanese Patent Application No. 2023-221569 filed on Dec. 27, 2023, incorporated herein by reference in its entirety.

### BACKGROUND

### 1. Technical Field

The present disclosure relates to a system and an information processing device.

### 2. Description of Related Art

In the related art, there is a technology of providing information related to a vehicle before delivery to a user. For example, Japanese Unexamined Patent Application Publication No. 2002-297954 (JP 2002-297954 A) discloses providing, to a user terminal, information related to a progress status of delivery of a vehicle, such as position information during transportation of the vehicle, for a vehicle purchased by a user before delivery.

### SUMMARY

Only the providing of the position information and the information like of the vehicle does not necessarily lead to a high probability that user's expectation in regard to the delivery of the vehicle is developed. In this manner, there has been room for improvement in a technology of developing user's expectation in regard to delivery of a vehicle.

A system according to the present disclosure is a system including: an information processing device that provides a website presenting information related to a vehicle purchased by a user and waiting for delivery;
a related product of the vehicle; and
a terminal device, wherein
the information processing device transmits product information indicating the related product to the terminal device, and
the terminal device
displays the product information and transmits order information indicating an order of the related product from the user to the information processing device.

An information processing device according to the present disclosure is an information processing device that provides a website presenting information related to a vehicle purchased by a user and waiting for delivery, the information processing device including:
a communication unit that communicates with a terminal device; and
a control unit that transmits product information indicating a related product of the vehicle to the terminal device via the communication unit and
receives order information indicating an order of the related product by the user from the terminal device via the communication unit.

According to the present disclosure, it is possible to improve a technology of developing user's expectation in regard to delivery of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment of the present disclosure; and

FIG. 2 is a flowchart illustrating an operation example of the system according to the present embodiment.

### DETAILED DESCRIPTION OF EMBODIMENTS

Hereinafter, a first embodiment of the present disclosure will be described with reference to the drawings. In the drawings, the same or corresponding parts are denoted by the same reference numerals. In the description of the present embodiment, description of the same or corresponding components will be appropriately omitted or simplified.

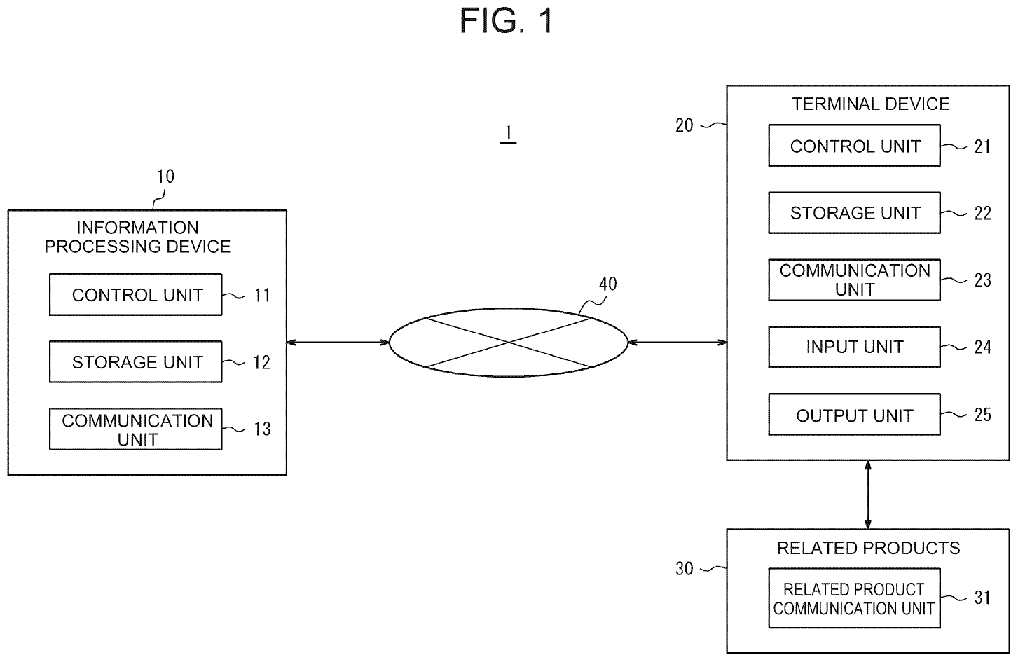

A configuration of the system 1 according to the present embodiment will be described with reference to FIG. 1. The system 1 includes an information processing device 10, a terminal device 20, and a related product 30. The information processing device 10 and the terminal device 20 are communicably connected to each other via a network 40 including, for example, the Internet. The terminal device 20 is communicably connected to the related product 30 as described below.

The information processing device 10 is a computer installed in a facility such as a data center. The information processing device 10 is, for example, a server belonging to a cloud computing system or another computing system.

The terminal device 20 is used by a user. The terminal device 20 is, for example, a mobile device such as a mobile phone, a smart phone, or a tablet, or a PC. The term “PC” is an abbreviation for “personal computer”. The terminal device 20 can receive information from the related product 30 by short-range wireless communication. Near-field communication includes communication in accordance with NFC standards, Bluetooth (registered trademark) standards, and the like. “NFC” is an abbreviation for Near Field Communication.

The related product 30 is a related product of a vehicle that is purchased by the user and is waiting for delivery. In the present embodiment, the related product 30 includes a model M of the vehicle. The related product 30 can transmit information to the terminal device 20 by short-range wireless communication.

The network 40 includes the Internet, at least one WAN, at least one MAN, or any combination thereof. The term “WAN” is an abbreviation for “wide area network”. The term “MAN” is an abbreviation for “metropolitan area network”. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

First, the outline of the present embodiment will be described, and the details will be described later. The system 1 includes an information processing device 10 that provides a website that presents information about a vehicle waiting for delivery, which is purchased by a user, a related product 30 of the vehicle, and a terminal device 20. The information processing device 10 transmits the product information indicating the related product 30 to the terminal device 20. The terminal device 20 displays the product information, and transmits order information indicating an order of the related product 30 by the user to the information processing device 10.

According to the present embodiment, the user can not only view information about the vehicle waiting for delivery but also order the related product 30 of the vehicle. By holding the related product 30 in advance of the actual vehicle, the possibility that the user's interest in the vehicle is maintained continuously even during the period before the delivery of the vehicle is improved. Therefore, it is possible to improve a technique for improving a user's expectation of delivery.

A configuration of the information processing device 10 according to the present embodiment will be described with reference to FIG. 1. The information processing device 10 includes a control unit 11, a storage unit 12, and a communication unit 13.

The control unit 11 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 11 executes processing related to the operation of the information processing device 10 while controlling each unit of the information processing device 10.

The storage unit 12 includes at least one semiconductor memory, at least one magnetic memory, at least one optical memory, or any combination thereof. The semiconductor memory is, for example, a RAM, a ROM, or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read only memory”. The flash memory is, for example, an SSD. The term “SSD” is an abbreviation for solid-state drive. The magnetic memory is, for example, an HDD. The term “HDD” is an abbreviation for hard disk drive. The storage unit 12 may function as, for example, a main storage device, an auxiliary storage device, or a cache memory. The storage unit 12 stores information used for the operation of the information processing device 10 and information obtained by the operation of the information processing device 10.

The communication unit 13 includes at least one communication interface. The communication interface is, for example, a LAN interface. The term “LAN” is an abbreviation for “local area network”. The communication unit 13 receives data used for the operation of the information processing device 10, and transmits data obtained by the operation of the information processing device 10.

A configuration of the terminal device 20 according to the present embodiment will be described. The terminal device 20 includes a control unit 21, a storage unit 22, a communication unit 23, an input unit 24, and an output unit 25. The hardware configurations of the control unit 21 and the storage unit 22 of the terminal device 20 may be the same as the hardware configurations of the control unit 11 and the storage unit 12 of the information processing device 10, respectively. The description here is omitted.

The communication unit 23 includes at least one communication interface. The communication interface is, for example, an interface compliant with a mobile communication standard such as LTE, 4G standard or 5G standard, or a wireless LAN communication standard such as IEEE 802.11. Alternatively, the communication interface is an interface compliant with a short-range radio communication standard such as Bluetooth (registered trademark). The term “LTE” is an abbreviation for “long term evolution”. The term “4G” is an abbreviation for “fourth generation”. The term “5G” is an abbreviation for “fifth generation”. The communication unit 23 communicates with the information processing device 10 and the related product 30. The communication unit 23 includes an antenna for short-range wireless communication. The communication unit 23 receives data used for the operation of the terminal device 20 and transmits data obtained by the operation of the terminal device 20.

The input unit 24 includes at least one input interface. The input interface is, for example, a physical key, a capacitive key, a pointing device, a touch screen integrated with a display, a camera, or a microphone. The input unit 24 receives an operation of inputting data used for the operation of the terminal device 20. Instead of being provided in the terminal device 20, the input unit 24 may be connected to the terminal device 20 as an external input device. As the connecting interface, an interface corresponding to a standard such as USB, HDMI (registered trademark) or Bluetooth (registered trademark) can be used. The term “USB” is an abbreviation for “universal serial bus”. The term “HDMI (registered trademark)” is an abbreviation for “high-definition multimedia interface”.

The output unit 25 includes at least one output interface. The output interface is, for example, a display or a speaker. The display is, for example, an LCD or an organic EL display. The term “LCD” is an abbreviation for “liquid crystal display”. The term “EL” is an abbreviation for “electroluminescent”. The output unit 25 outputs data obtained by the operation of the terminal device 20. The output unit 25 may be connected to the terminal device 20 as an external output device instead of being provided in the terminal device 20. As the connecting interface, an interface corresponding to a standard such as USB, HDMI (registered trademark) or Bluetooth (registered trademark) can be used.

A configuration of the related product 30 according to the present embodiment will be described. The related product 30 includes a related product communication unit 31. The hardware configuration of the related product communication unit 31 may be the same as the hardware configuration of the communication unit 23 of the terminal device 20. The related product communication unit 31 may include a RFID tag such as an NFC tag, a QR code (registered trademark), and the like. Further, “RFID” is an abbreviation of Radio Frequency Identification.

The terminal device 20 reads NFC tag or the like by using the antenna as the communication unit 23, so that it is possible to acquire URL indicating the position of the video data on the Internet. “URL” is an abbreviation for Uniform Resource Locator. The terminal device 20 may acquire the information by reading QR code (registered trademark) as the related product communication unit 31 using the camera as the input unit 24. The website on which the video data indicated by URL is posted may be provided by the information processing device 10 or may be provided by an external apparatus that differs from the information processing device 10. By accessing URL, the terminal device 20 can acquire video data.

The related product 30 may further include a related product storage unit that stores video data captured during production of the vehicle waiting for delivery. The hardware configuration of the related product storage unit may be the same as the hardware configuration of the storage unit 12 of the information processing device 10. The related product 30 may further include a related product control unit connected to the related product communication unit 31 and the related product storage unit. In this case, the related product control unit can transmit the video data read from the related product storage unit to the terminal device 20 via the related product communication unit 31 by Bluetooth (registered trademark) or the like.

The related product 30 may include, in addition to the related product storage unit, a related product output unit such as a USB terminal. The hardware configuration of the related product output unit may be the same as the hardware configuration of the output unit 25 of the terminal device 20. For example, by connecting the related product output unit to the terminal device 20, the video data stored in the related product storage unit can be directly output to the terminal device 20.

The functions of the information processing device 10 or the terminal device 20 are realized by executing the program according to the present embodiment by a processor serving as the control unit 11 or the control unit 21. That is, the functions of the information processing device 10 or the terminal device 20 are realized by software. The program causes the computer to execute the operation of the information processing device 10 or the terminal device 20, thereby causing the computer to function as the information processing device 10 or the terminal device 20. That is, the computer functions as the information processing device 10 or the terminal device 20 by executing the operation of the information processing device 10 or the terminal device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

Part or all of the functions of the information processing device 10 or the terminal device 20 may be realized by a programmable circuit or a dedicated circuit as the control unit 11 or the control unit 21. That is, some or all of the functions of the information processing device 10 or the terminal device 20 may be realized by hardware.

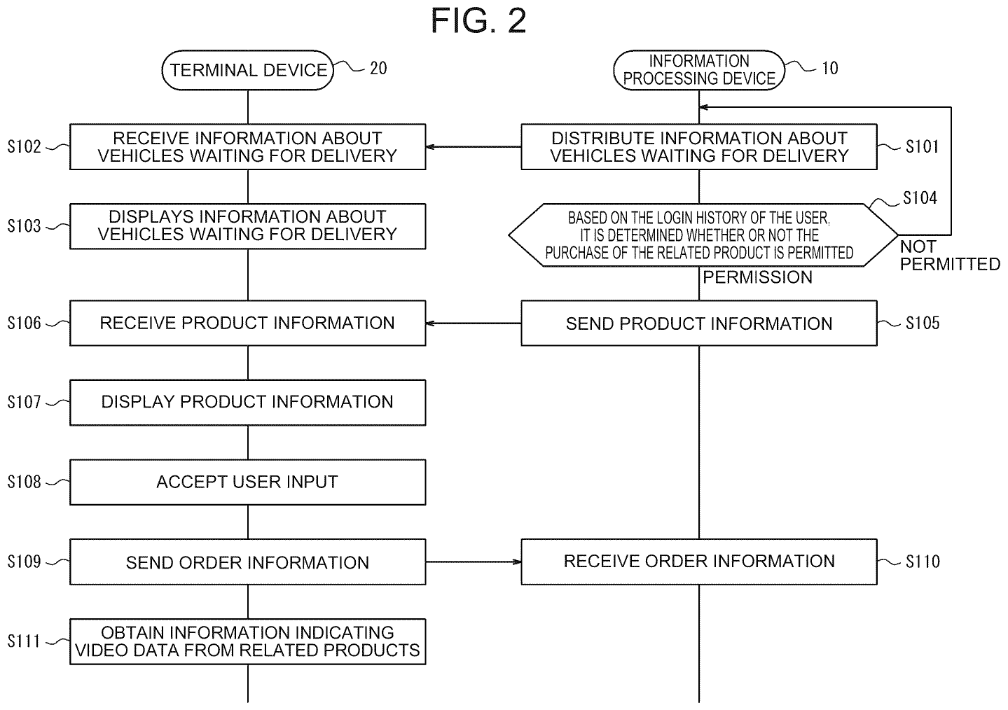

The operation of the system 1 according to the present embodiment will be described with reference to FIG. 2. In the following description, communication between the information processing device 10 and the external apparatus is performed via the communication unit 13 and the network 40.

In S101 of FIG. 2, the control unit 11 of the information processing device 10 transmits information about vehicles waiting for delivery to the terminal device 20. At least a part of the information according to the present embodiment is content of a website that can be browsed by logging in after authentication using a password or the like. The information about the vehicle waiting for delivery may include information indicating a production process of the vehicle, or information about a production factory or the like.

In S102, the control unit 21 of the terminal device 20 receives information about vehicles waiting for delivery.

In S103, the control unit 21 displays information about vehicles waiting for delivery via the output unit 25. In this way, the information on the vehicle waiting for delivery is displayed on the terminal device 20 as the content of the website.

In S104, the control unit 11 of the information processing device 10 determines whether to permit purchasing of the related product 30 based on the log-in history of the user to the website. When it is determined that the related product 30 is permitted to be purchased, the process of the control unit 11 proceeds to S105. When it is determined that the purchase of the related product 30 is not permitted, the processing of the control unit 11 returns to the start. The information indicating the login history to the website is information for recording the identifier of the user and information related to the login such as the total number of times of login or the time of login in association with each other, and may be stored in the storage unit 12 of the information processing device 10. The information may be information including the number of times of login for each predetermined period, such as one day or one week. Each time the user logs in to the website, the control unit 11 counts up the total number of times of login or the number of times of login for each predetermined period, and updates information indicating the login history.

Any method may be employed to determine whether to permit the purchase of the related product 30. For example, the control unit 11 may refer to the information indicating the login history, permit the purchase when the total number of times of login indicated by the login history is equal to or greater than a predetermined value, and decide not to permit the purchase when the total number of times of login indicated by the login history is less than the predetermined value. For example, the control unit 11 may determine that the purchase is permitted when the login history indicates that at least one login is continuously performed for a predetermined number of days or more every day, and that the purchase is not permitted when the login history is less than the predetermined number of days. The information indicating the predetermined value or the predetermined number of days may be stored in the storage unit 12 in advance. For example, the information indicating the login history may include information indicating whether the user has responded to a questionnaire related to the vehicle before delivery presented after the login. At this time, the control unit 11 may determine that the purchase is permitted when the user has answered the questionnaire, and that the purchase is not permitted when the user has not answered the questionnaire. The questionnaire may include, for example, a question about a period of waiting for delivery, a question about a destination to be visited by a vehicle waiting for delivery, and the like.

In S105, the control unit 21 generates commodity information indicating the related product 30 of the vehicle, and transmits the commodity information to the terminal device 20. In the present embodiment, the related product 30 is the model M of the vehicle waiting for delivery. The related product 30 is not limited to this, and may include any article such as a medal, a badge, a tableware such as a tumbler, a stationery, a PC peripheral, or the like in which the vehicle type is entered. The commodity information may include a price, a characteristic, and the like of the related product 30.

In S106, the control unit 21 of the terminal device 20 receives the commodity data.

In S107, the control unit 21 displays the product data via the output unit 25.

In S108, the control unit 21 receives, via the input unit 24, a user input for ordering the related product 30 indicated by the product information.

In S109, the control unit 21 generates order information indicating an order of the related product 30 based on the user input received by S108, and transmits the order information to the information processing device 10. The order information may include the number of orders of the related product 30, a shipping destination of the related product, information necessary for payment, and the like.

In S110, the control unit 11 of the information processing device 10 receives the ordering information from the terminal device 20. The control unit 11 performs order processing based on the order information. In the present example, the model M as the related product 30 is shipped to the user based on the order processing.

In S111, the control unit 21 of the terminal device 20 acquires, from the related product 30 that has arrived at the source of the user, information indicating video data captured during production of the vehicle. In the present embodiment, the control unit 21 communicates with the related product communication unit 31 of the model M, reads the information indicating URL indicating the website on which the video data is posted, and acquires the video data by accessing the website and downloading the video data. The image data includes, for example, an image captured in a factory or the like in a production process of a vehicle or an accessory of the vehicle. In addition, the image data includes, for example, an image including a scenery of a vehicle or a route on which the equipment of the vehicle is conveyed. In addition, the video data includes, for example, an arbitrary video relating to the vehicle, such as a video describing the function of the vehicle or the equipment of the vehicle. In addition to the video data, the control unit 21 may also acquire image data, text data, or the like related to the vehicle waiting for delivery. Thereafter, the operation of the system 1 ends.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

For example, in the above-described S104 and S105, the control unit 11 of the information processing device 10 may determine to increase or change the video data that can be acquired by the terminal device 20 via the related product 30 in accordance with the number of times the user logs in to the website. In this case, the control unit 11 generates commodity information indicating an outline of the video data according to the determination, and transmits the commodity information to the terminal device 20. For example, the control unit 11 may determine to provide video data of a larger type or a longer time as the number of times the user logs in, generate product information indicating an outline of the video data according to the determination, and transmit the product information to the terminal device 20. The video data corresponding to the determination may be stored in a website indicated by the information indicating the video data acquired from the related product 30 by the terminal device 20. As the number of times of login to the website increases, the video data increases, so that the likelihood that the number of times the user views the website increases, and consequently, the user's expectation for delivery improves.

What is claimed is:

1. A system comprising:
an information processing device that provides a website presenting information related to a vehicle purchased by a user and waiting for delivery;
a related product of the vehicle; and
a terminal device, wherein
the information processing device transmits product information indicating the related product to the terminal device, and
the terminal device displays the product information and transmits order information indicating an order of the related product from the user to the information processing device.

2. The system according to claim 1, wherein the information processing device permits the user to purchase the related product based on a login history of the user to the website.

3. The system according to claim 1, wherein the related product includes a related product communication unit capable of transmitting information indicating video data imaged during production of the vehicle to the terminal device.

4. The system according to claim 1, wherein the related product is a model of the vehicle.

5. An information processing device that provides a website presenting information related to a vehicle purchased by a user and waiting for delivery, the information processing device comprising:
a communication unit that communicates with a terminal device; and
a control unit that transmits product information indicating a related product of the vehicle to the terminal device via the communication unit and receives order information indicating an order of the related product by the user from the terminal device via the communication unit.
